(19) United States
(12) Patent Application Publication
(10) Pub. No.: US 2006/0168921 A1
(43) Pub. Date: Aug. 3, 2006

(54) Oil gas filtering device

(75) Inventor: Chieh-Yuan Cheng, Taichung (TW)

Correspondence Address: TROXELL LAW OFFICE PLLC, SUITE 1404, 5205 LEESBURG PIKE, FALLS CHURCH, VA, 22041, US

(73) Assignee: San Ford Machinery Co., Ltd.

(21) Appl. No.: 11/044,069

(22) Filed: Jan. 28, 2005

(51) Int. Cl. B01D 50/00

(52) U.S. Cl. 55/337

(57) ABSTRACT

An oil gas filtering device includes a housing having a barrel, The interior of the barrel is partitioned into a front and a rear air chamber by a wind shade. The barrel has its front upper sidewall bored with a wind intake. External oil gas is sucked in the front air chamber through the wind intake to be turned and swirled to have oil stain separated out and guided out through a guiding vent. Then, the oil gas in the wind shade is exhausted out by a turbine blade to get in the rear air chamber to be turned and swirled for a second time to have more oil stain separated out and exhausted out through the other guiding vent. Finally, the oil gas with little stain is filtered by a filtering member to become clean air.

### BACKGROUND OF THE INVENTION

1. Field of the Invention

This invention relates to an oil gas filtering device, particularly to one able to effectively separate oil stain from oil gas, able to prolong the service life of a filtering member and lower its cost.

2. Description of the Prior Art

Generally, when a mechanical processing machine carries out processing of knives or other metal articles, it is always necessary to continuously spray special lubricating oil on the parts being processed so as to smoothly carry out cutting and shaving of tools or metal articles and prevent them from being damaged due to excessively high temperature. Nevertheless, the lubricating oil used during processing will vaporize and float about to fill the air and mix with impurities or dust produced during processing, not only polluting environment but also affecting workers' health. In order to improve this condition, a casing and an oil gas filtering device are provided on the mechanical processing machine. Thus, the oil gas produced during lubricating and processing can be sucked in the oil gas filtering device through the casing and properly filtered therein, and then the filtered and clean air is exhausted out, able to avoid polluting the environment and deteriorating workers' health.

However, the conventional oil gas filtering device completely depends upon its inner filtering member for carrying out filtering of oil gas that contains a great quantity of oil stain; therefore, after used for a period of time, the filtering member in the oil gas filtering device will be clogged with oil stain attached thereon, rendering the filtering member unable to carry out filtering. As a result, the filtering member has to be detached from the oil gas filtering device and cleaned up or replaced with a new one, increasing cost in using materials and not profitable to economic gain.

### SUMMARY OF THE INVENTION

The objective of the invention is to offer an oil gas filtering device including a housing having a barrel, which has its interior partitioned into a front and a rear air chamber by a wind shade and its front upper side wall bored with a wind intake. Oil gas can be sucked in the front air chamber of the barrel through the wind intake and forced by a turning and swirling centrifugal force to have its oil stain separated out and then exhausted out through a guiding vent in the bottom of the front air chamber. Subsequently, the oil gas guided in the interior of the wind shade is exhausted out by a turbine blade to get into the rear air chamber to be turned and swirled for a second time to have more oil stain separated out and then exhausted out through the other guiding vent in the bottom of the rear air chamber. Finally, the oil gas with little stain and impurities is filtered by a filtering member, and then filtered and clean air is exhausted out, thus preventing a filtering member from being clogged with oil stain in a short time and able to prolong service life of the filtering member.

### BRIEF DESCRIPTION OF DRAWINGS

This invention will be better understood by referring to the accompanying drawings, wherein:

FIG. 1 is a perspective view of an oil gas filtering device in the present invention:

FIG. 2 is a partial exploded perspective view of the oil gas filtering device in the present invention:

FIG. 3 is a partial side cross-sectional view of the oil gas filtering device in the present invention: and

FIG. 4 is a side cross-sectional view of the oil gas filtering device in the present invention, showing a condition that oil stain is filtered and separated from oil gas.

### DETAILED DESCRIPTION OF THE PREFERRED EMBODIMENT

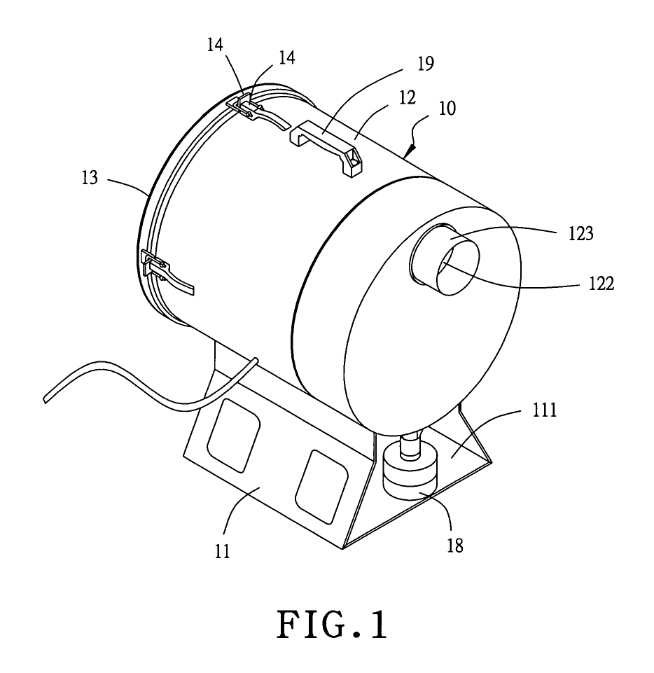

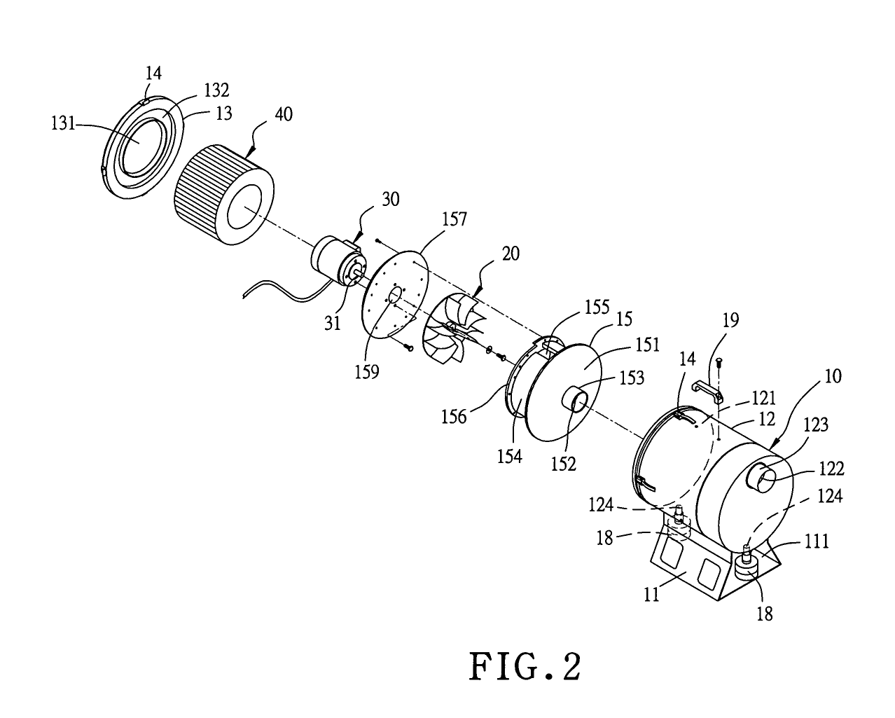

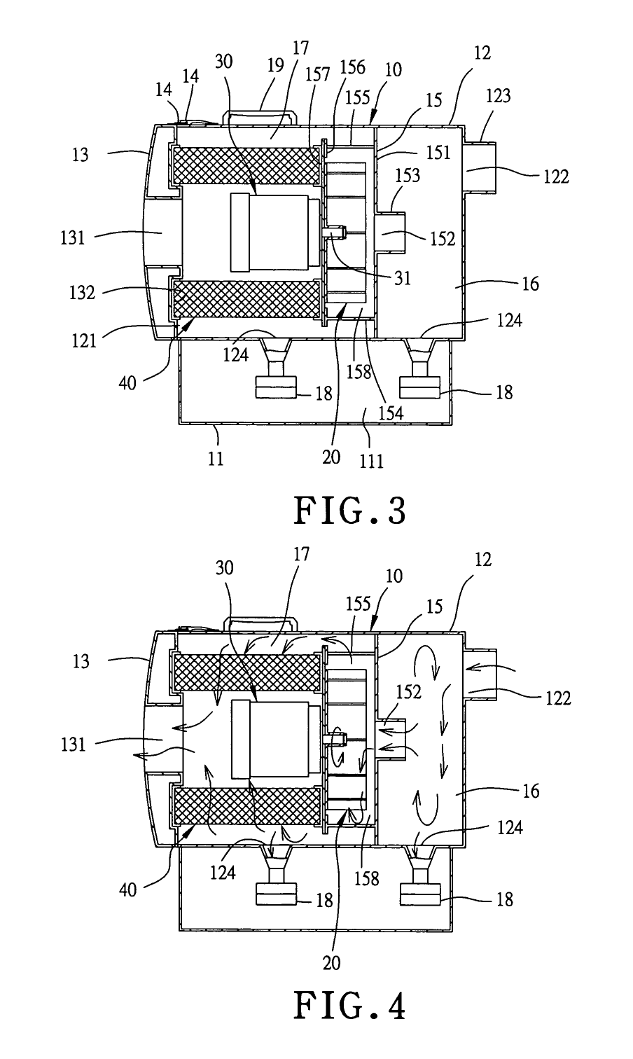

A preferred embodiment of an oil gas filtering device in the present invention, as shown in FIGS. 1 and 2, includes a housing 10, a turbine blade 20, a motor 30 and a cylindrical filtering member 40 combined together.

The housing 10 is provided with a support frame 11 formed with an accommodating space 111 in the interior and a round barrel 12 fixed on the support frame 11 and having its rear side bored with an opening 121 closed up by a barrel cover 13. The barrel cover 13 has its central portion bored with a wind-exhausting vent 131 and its inner wall formed with a recessed annular positioning groove 132. A plurality of male-female buckles 14 are provided on the circumferential edge of the barrel cover 13 and the rear outer wall of the barrel 12 for mutually clasping one another and covering the barrel cover 13 on the barrel 12. Further, the barrel 12 has its front upper side wall bored with a wind intake 122 extending outward and forming a tubular mouth 123 for external oil gas to be sucked into the barrel 12 therethrough.

A wind shade 15 is disposed at a proper location in the interior of the barrel 12 and formed with a separating plate 151 to partition the interior of the barrel 12 into a front air chamber 16 and rear air chamber 17. The separating plate 151 is bored in the center with guiding intake 152 having a tubular mouth 153 communicating with and extending in the front air chamber 16. In addition, extending outward from the separating plate 151 is a cylindrical casing 154 having its upper wall bored with a guiding outlet 155 and its rear side formed with an annular fixing edge 156, which is locked with the circumferential edge of a round-shaped motor fixing plate 157 for sealing up the cylindrical casing 154 so that an accommodating chamber 158 is defined by the motor fixing plate 157, the separating plate 151 and the cylindrical casing 154. The motor fixing plate 157 is bored with an insert hole 159 in the center, and the front and the rear air chamber 16, 17 of the barrel 12 have their bottom wall respectively bored with a guiding outlet 124 connected with an oil-collecting container 18 received in the accommodating space 111 of the support frame 11. Further, a handle 19 is secured at the upper outer wall of the barrel 12 for a user to carry the oil gas filtering device about.

The turbine blade 20 is received in the accommodating chamber 156 of the wind shade 15 positioned in the barrel 12 of the machine base 10.

The motor 30 secured on the rear wall of the motor fixing plate 157 of the wind shade 15 is provided with an output shaft 31 inserted through the insert hole 159 of the motor fixing plate 157 and connected with the turbine blade 20 for driving the turbine blade 20 to rotate.

The cylindrical filtering member 40 is fitted between the motor fixing plate 157 in the barrel 12 and the barrel cover 13 and has its rear end embedded stably in the annular positioning groove 132 in the inner wall of the barrel cover 13.

In operating, as shown in FIG. 4, when the motor 30 of the oil gas filtering device is started, the turbine blade 20 in the wind shade 15 will be driven to rotate and produce a vacuum suction force at the wind intake 122 in the front upper side wall of the barrel 12 to suck oil gas produced by a mechanical processing machine into the front air chamber 16 of the barrel 12. The wind intake 122 of the barrel 12 is positioned at a vertical level higher than that of the guiding intake 152 of the wind shade 15; therefore, when oil gas is sucked in the front air chamber 16 of the barrel 12, the oil gas will not immediately and directly be guided into the accommodating chamber 158 of the wind shade 15, but be turned and swirled in the front air chamber 16 and produce a turning and swirling centrifugal force to separate oil stain from the oil gas. Then, the oil stain, by its own gravity, will flow downward to the guiding vent 124 at the bottom of the front air chamber 16 to be collected by the oil-collecting container 8 beneath the guiding vent 124. Subsequently, the oil gas, after turned and swirled for the first time, will get in the accommodating chamber 158 of the wind shade 15 through the guiding intake 152 to be turned around by the turbine blade 20 in the accommodating chamber 158 and exhausted out through the guiding outlet 155 in the upper side of the cylindrical casing 154. Simultaneously, the oil gas will get in the rear air chamber 17 formed between the outer wall of the wind shade 15 and the inner wall of the barrel 12 to be turned and swirled for a second time to have oil stain once again separated from the oil gas by a turning and casting centrifugal force. Then, the oil stain, by its own gravity, will flow downward to the other guiding vent 124 at the bottom of the rear air chamber 17 to be collected by the other oil-collecting container 18 beneath the guiding vent 124. Thus, after the gas oil is turned and swirled with centrifugal force for two times, most oil stain in the oil gas can be separated out and collected, while the remaining oil with little oil stain and impurities can be filtered by the filtering member 40 positioned between the wind shade 15 and the barrel cover 13, and afterward filtered and clean air is exhausted out through the interior of the filtering member 40 and the wind-exhausting vent 131 in the center of the barrel cover 13.

By so designing, the oil gas filtering device of this invention can effectively filter the oil gas produced by a mechanical processing machine. After most oil stain is separated from the oil gas by turning and swirling centrifugal force for two times, the oil gas with little oil stain and impurity is filtered by the filtering member 40. Therefore, it is not necessary to completely depend on the filtering member 40 for carrying out filtering of the oil gas, able to prevent the filtering member 40 from being clogged with oil stain in a short period of time to prolong its service life and lower cost in using materials.

While the preferred embodiment of the invention has been described above, it will be recognized and understood that various modifications may be made therein and the appended claims are intended to cover all such modifications that may fall within the spirit and scope of the invention.

I claim:

1. An oil gas filtering device comprising:
A housing having a barrel, said barrel having its rear side bored with an opening closed up by a barrel cover, said barrel cover bored with a wind exhausting vent in the center, said barrel further having its front upper side wall bored with a wind intake for external oil gas to be sucked in therethrough, a wind shade fitted at a proper location in the interior of said barrel, said wind shade partitioning the interior of said barrel into a front air chamber and a rear air chamber, said wind intake communicating with said front air chamber, said wind shade having its interior formed with an accommodating chamber communicating with said front air chamber, said accommodating chamber of said wind shade having its upper circumferential wall bored with a guiding outlet communicating with said rear air chamber of said barrel, said barrel having its bottom wall bored with two guiding vents spaced apart and respectively communicating with said front and said rear air chamber, said guiding vents respectively guiding and exhausting out oil stain:
A turbine blade received in said accommodating chamber of said wind shade in said barrel, said turbine blade driven to rotate and suck the oil gas in said front air chamber into said wind shade, said oil gas exhausted out of said wind shade to flow in said rear air chamber through said guiding outlet:
A motor secured at the rear side of said wind shade, said motor provided with an output shaft for driving said turbine blade to rotate: and
A filtering member fitted in said barrel and positioned in said rear air chamber formed between said wind shade and said barrel cover, said filtering member filtering little oil stain and impurities remained the oil gas guided in said rear air chamber, filtered and clean air exhausted out through the interior of said filtering member and said wind-exhausting vent of said barrel cover.

2. The oil gas filtering device as claimed in claim 1, wherein said wind shade is provided with a separating plate positioned and sealed at a proper location in the interior of said barrel and bored in the center with a guiding intake communicating with said front air chamber, said separating plate having a cylindrical casing extending backward, said cylindrical casing having its upper outer wall bored with a guiding outlet, said cylindrical casing having its rear side formed with an annular fixing edge to be firmly combined with the circumferential edge of a round-shaped motor fixing plate, an accommodating chamber defined by said motor fixing plate, said separating plate and said cylindrical casing, said motor fixing plate bored with an insert hole in the center for said output shaft of said motor to be inserted therethrough.

3. The oil gas filtering device as claimed in claim 1, wherein said guiding vents in the bottom of said front and said rear air chamber of said barrel are respectively connected with an oil-collecting container.

4. The oil gas filtering device as claimed in claim 1, wherein said barrel cover has its front side wall formed with a recessed annular positioning groove for the corresponding end of said filtering member to be embedded stably therein.

5. The oil gas filtering device as claimed in claim 1, wherein a plurality of male-female buckles are provided on the circumferential edge of said barrel cover and the rear outer wall of said barrel for mutually clasping one another and positioning said barrel cover on said barrel.

6. The oil gas filtering device as claimed in claim 1, wherein said wind intake bored in the front upper side wall of said barrel extends outward to form a tubular mouth.

7. The oil gas filtering device as claimed in claim 2, wherein said central guiding intake of said separating plate of said wind shade extends outward to form a tubular mouth extending in said front air chamber.

8. The oil gas filtering device as claimed in claim 1, wherein a support frame is fixed at the bottom of said barrel of said machine base, having its interior formed with an accommodating space for receiving said two oil-collecting containers beneath said barrel.

9. The oil gas filtering device as claimed in claim 1, wherein a handle is secured at a proper location on the outer wall of said barrel.
